(19) United States
(12) Patent Application Publication
(10) Pub. No.: US 2019/0061546 A1
(43) Pub. Date: Feb. 28, 2019

(54) APPLICATION PROGRAMMING INTERFACE FOR INTEGRATING ELECTRIC VEHICLE COMPONENTS WITH VEHICLE CHARGING NETWORK

(71) Applicant: Electric Motor Werks, Inc., San Carlos, CA (US)

(72) Inventor: Valery Miftakhov, San Carlos, CA (US)

(21) Appl. No.: 15/690,264

(22) Filed: Aug. 29, 2017

(51) Int. Cl. B60L 11/18; H02J 3/38

(52) U.S. Cl. CPC B60L 11/1842; H02J 3/38; B60L 11/1824; B60L 11/1838

(57) ABSTRACT

An electric or hybrid-electric vehicle incorporating: a vehicle battery adopted to store electrical power; a battery charger electrically coupled to the battery and configured to perform charging of the vehicle battery from an external power source; and a battery management system electrically coupled to the vehicle battery and the battery charger and configured to manage a state of the vehicle battery. At least one of the battery, the battery charger or the battery management system provides an application programming interface accessible, via a data network, by an application program executing on a remote control server. The application programming interface may be used for obtaining various data from the vehicle, such as vehicle battery cost of control, and/or for controlling one or more parameters of the respective electric vehicle components, such as reactive power of the battery charger.

### BACKGROUND OF THE INVENTION

### Field of the Invention

The disclosed embodiments relate in general to electric vehicle charging technology, and, more specifically, to an application programming interface (API) for vehicle charging network that could be used by vehicle manufacturers.

### Description of the Related Art

Currently, electric vehicle supply equipment (EVSE, aka EV charging stations) does/do not provide automatic responses to local conditions or to the changing needs of the larger electric power grid. Services that might be provided by automatic dispatch include optimization and reliability functions for the local residential, industrial, or commercial site. They may also include local site functions that can help stabilize the wider power grid. Such functions may include reducing EVSE electrical load or turning EVSE off altogether during times of peak demand or even using electrical energy stored in electric or hybrid electric vehicle (EV/PHEV) to temporarily provide additional necessary power into the electrical grid.

On the other hand, many OEM manufacturers do not allow batteries on their vehicles to be used for electric grid balancing because of the inability of the conventional grid management systems to properly interface with various components of the electric vehicle and the associated risk of battery damage. Providing a proper application programming interface (API) for interfacing various OEM components of the electric vehicle with the vehicle charging network would solve this problem.

### SUMMARY OF THE INVENTION

The inventive methodology is directed to methods and systems that substantially obviate one or more of the above and other problems associated with conventional EV/PHEV charging technology.

In accordance with one aspect of the embodiments described herein, there is provided an electric or hybrid-electric vehicle incorporating: a vehicle battery adopted to store electrical power; a battery charger electrically coupled to the battery and configured to perform charging of the vehicle battery from an external power source; and a battery management system electrically coupled to the vehicle battery and the battery charger and configured to manage a state of the vehicle battery, wherein at least one of the battery, the battery charger or the battery management system provides an application programming interface accessible, via a data network, by an application program executing on a remote control server incorporating at least one processing unit and a memory.

In one or more embodiments, the battery management system of the vehicle comprises the application programming interface.

In one or more embodiments, the application programming interface is configured to enable the application program executing on the remote control server to access cost of control data for the vehicle battery.

In one or more embodiments, the cost of control data for the vehicle battery indicates physical degradation of the vehicle battery from a predetermined operating mode.

In one or more embodiments, the battery management system is configured to receive, via the application programming interface, a command from the application program executing on the remote control server.

In one or more embodiments, the battery management system is further configured to alter its operating mode based on the command received from the application program executing on the remote control server.

In one or more embodiments, the command as an application programming interface function call.

In one or more embodiments, the battery of the vehicle comprises the application programming interface.

In one or more embodiments, the battery charger of the vehicle comprises the application programming interface.

In one or more embodiments, the battery charger is configured to receive, via the application programming interface, a command from the application program executing on the remote control server.

In one or more embodiments, the battery charger is further configured to alter its operating mode based on the command received from the application program executing on the remote control server.

In one or more embodiments, the command received from the application program executing on the remote control server causes the battery charger to alter a reactive power load.

In one or more embodiments, the command as an application programming interface function call.

In accordance with another aspect of the embodiments described herein, there is provided a method performed in connection with an electric or hybrid-electric vehicle involving: providing a vehicle battery adopted to store electrical power; charging of the vehicle battery from an external power source using a battery charger electrically coupled to the battery; and managing a state of the vehicle battery using a battery management system electrically coupled to the vehicle battery and the battery charger, wherein at least one of the battery, the battery charger or the battery management system provides an application programming interface accessible, via a data network, by an application program executing on a remote control server incorporating at least one processing unit and a memory.

In one or more embodiments, the battery management system of the vehicle comprises the application programming interface.

In one or more embodiments, the application programming interface is configured to enable the application program executing on the remote control server to access cost of control data for the vehicle battery.

In one or more embodiments, the cost of control data for the vehicle battery indicates physical degradation of the vehicle battery from a predetermined operating mode.

In one or more embodiments, the battery management system is configured to receive, via the application programming interface, a command from the application program executing on the remote control server.

In one or more embodiments, the battery management system is further configured to alter its operating mode based on the command received from the application program executing on the remote control server.

In accordance with yet another aspect of the embodiments described herein, there is provided a non-transitory computer-readable medium embodying a set of instructions, which, when executed in connection with an electric or hybrid-electric vehicle incorporating a vehicle battery adopted to store electrical power, a battery charger electrically coupled to the battery; and a battery management system electrically coupled to the vehicle battery and the battery charger, cause the electric or hybrid-electric vehicle to: charge the vehicle battery from an external power source using the battery charger; and manage a state of the vehicle battery using the battery management system, wherein at least one of the battery, the battery charger or the battery management system provides an application programming interface accessible, via a data network, by an application program executing on a remote control server incorporating at least one processing unit and a memory.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a vehicle charging network interacting through the inventive application programming interface with various OEM vehicle components.

FIG. 2 illustrates voltage and current drawn by a reactive electrical power component.

FIG. 3 is a block diagram that illustrates an embodiment of a computer/server system upon which an embodiment of the inventive technology may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

In accordance with one aspect of the embodiments described herein, there is provided a standardized application programming interface (API) that could be used by vehicle manufacturers to enable the vehicle charging network to interact with the various original equipment manufacturer (OEM) components of the electric vehicle such as batteries, battery chargers and battery management systems (BMS).

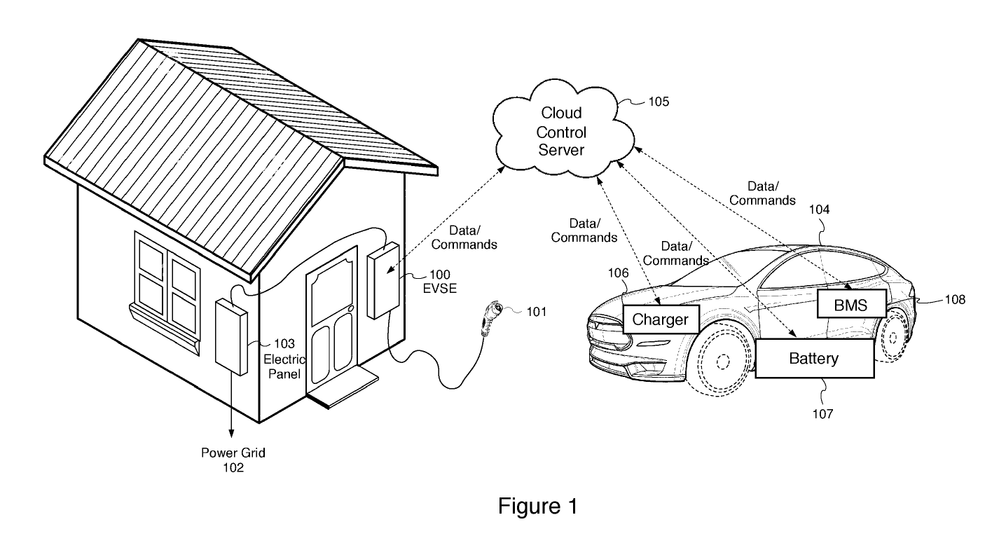

An exemplary embodiment of a vehicle charging network interacting through the inventive application programming interface with various OEM vehicle components is illustrated in FIG. 1. In one or more embodiments, the vehicle charging network shown in FIG. 1 comprises a cloud control server 105 for controlling multiple EVSE 100 via a data network. The EVSE 100 is connected to electric power grid 102 via house's electric panel 103. In one or more embodiments, the EVSE 100 is electrically coupled to an electric or hybrid vehicle 104 using a charge plug 101. The cloud control server 105 may send and/or receive data and send commands to the application programming interface of the EVSE 100 via the data network, such as Internet. In one embodiment, the cloud control server 105 controls the one or more EVSE 100 in response to predetermined electrical grid conditions. For example, in the event an electrical grid overload is detected, the cloud control server 105 may use the described application programming interface to instruct the one or more EVSE 100 to reduce or entirely turn off the vehicle charging current. In another embodiment, the cloud control server 105 may use the described application programming interface to instruct the one or more EVSE 100 to use electric energy stored in battery of the electric or hybrid vehicle to balance the grid during times of peak demand. Exemplary implementations of the local autonomous response to grid conditions are discussed in detail in U.S. patent application Ser. No. 15/004,974, incorporated herein by reference.

In one or more embodiments, the electric or hybrid vehicle 104 incorporates a battery 107, which could be a lithium battery. In one embodiment, the vehicle battery 107 is a lithium cobalt battery. In another embodiment, the vehicle battery 107 is a lithium metal phosphate battery, such as lithium iron phosphate. The electric or hybrid vehicle 104 is further equipped with a battery charger 106, which is configured to charge the vehicle battery 107. In one or more embodiments, the electric or hybrid vehicle 104 is further equipped with a battery management system 108, configured to manage the vehicle battery 107 by protecting the vehicle battery 107 from operating outside its safe operating area, monitoring its state, calculating secondary data, reporting that data, controlling its environment, authenticating it and/or balancing it.

In one or more embodiments, all the above vehicle components, including the vehicle battery 107, the charger 106 and the battery management system 108 as well as the EVSE 100 are configured to exchange data and commands with the cloud control server 105 via the aforesaid application programming interface. In one or more embodiments, the application programming interface is a standardized open interface enabling various OEM manufacturers to provide integration of their respective manufactured components with the cloud control server 105 for purposes of providing an automated grid response described above.

In one or more embodiments, the battery management system (BMS) 108 provides an application programming interface accessible by the cloud control server 105. The aforesaid application programming interface may incorporate various API function calls that are designed to enable access of the various software applications executing on the cloud control server 105 to the various functions performed by the battery management system (BMS) 108 of the electric or hybrid vehicle 104. In addition to accessing and/or setting parameters of various conventional functions of the battery management system (BMS) 108, such as defining the safe operating area, monitoring its state, calculating secondary data or performing balancing, the application programming interface of the battery management system (BMS) 108 may additionally enable access to various advanced parameters, such as a cost of control of the vehicle battery 107. By obtaining the aforesaid cost of control parameter of the vehicle battery 107 from the battery management system (BMS) 108 through the inventive application programming interface enables, for example, the cloud control server 105 to calculate a cost of physical battery degradation from a specific battery operating mode, such as providing a predetermined amount of electrical power back into the electric power grid 102.

In one or more embodiments, the cloud control server 105 uses the BMS’ 108 knowledge of the economics of the battery 107 with respect to any VGI (vehicle-grid integration) controls, such as providing a predetermined amount of electrical power from the battery 107 back into the electric power grid 102. To this end, the cloud control server 105 uses the application programming interface of the BMS 108 to request from the BMS 108 the estimated ‘cost’ of the proposed ‘event’ before executing the event and then taking the received information into account to determine dispatch instructions given battery and grid economics. One example of the ‘cost’ associated with the event is battery degradation cost associated with using the electrical charge stored in the battery to balance grid 102.

In one example, a predetermined application programming interface function call is made by the cloud control server 105 to the BMS 108. The software operating on the cloud control server 105 may be configured to analyze the cost of battery degradation returned by the BMS 108 in response to the aforesaid application programming interface function call and perform the aforesaid proposed operation only if the cost of battery degradation does not exceed a predetermine threshold. As would be appreciated by persons of ordinary skill in the art, such functionality would enable the batteries of the electric and hybrid vehicles to be used for providing autonomous grid response while controlling the associated battery degradation costs. Such cost control capability would prompt more OEM manufacturers to open the corresponding functionality and enable more efficient electric power grid management.

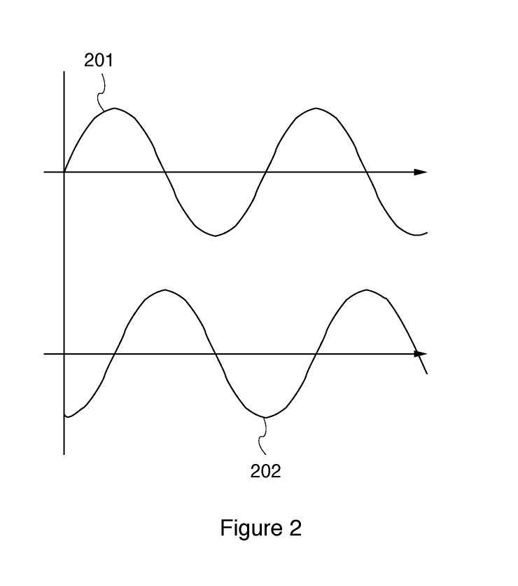

In another exemplary embodiment, the vehicle battery charger 106 may provide the aforesaid application programming interface for enabling the applications executing on the cloud control server to control reactive electrical power drawn by the vehicle battery charger 106. As it is well known in the art, reactive power exists in an alternating current (AC) circuit when the current and voltage are not in phase, as shown, for example in FIG. 2. In that figure voltage 201 and current 202 are phase-shifted with respect to one another. As it is also well known to persons of ordinary skill in the art, reactive power occurs in circuits having one or more reactive components, such as when the system possesses capacitance, inductance, or both. These electrical properties cause the current to change phase with respect to the voltage: capacitance tending the current to lead the voltage in phase, and inductance to lag it.

As would be appreciated by persons of ordinary skill in the art, reactive power loads present a major challenge for the electrical power grid. Because reactive power does not do any real work, the extra current supplied to provide the reactive power causes greater transmission line losses and higher thermal limits for the power distribution equipment, which translate to higher costs to electric grid operators. Therefore, managing the reactive power flow in addition to real power flow becomes a very important task for operators to ensure voltage stability throughout the system.

Therefore, in one embodiment, the vehicle battery charger 106 is provided with an application programming interface (API) for controlling the reactive power. In one embodiment, this application programming interface could be used by software executing on the cloud control server 105 to send appropriate commands to the vehicle battery charger 106 in order to control the reactive power in the electrical grid 102. As would be appreciate by persons of ordinary skill in the art, such functionality enables more effective electrical power grid balancing by the cloud control server 105.

In yet another example, the EVSE 100 is provided with an application programming interface (API) for reporting telemetry of the power grid 102. In one embodiment, this application programming interface could be used by software executing on the cloud control server 105 to receive near real-time information on the power quality of the grid 102, including, without limitation, voltage, frequency, and waveform of the grid power.

As would be appreciated by persons of ordinary skill in the art, the above three examples of the uses of the inventive application programming interface (API) in various OEM components of the electric or hybrid vehicle 104 are not exhaustive and many other operating parameters may be gathered and/or controlled using the inventive application programming interface (API). Such parameters may include, without limitation, the resistive power load as well as various environmental characteristics. Therefore, the described inventive application programming interface (API) is not limited to controlling any specific parameters, operating modes or other characteristics.

In one or more embodiments, the charger 106 may be implemented as a fast battery charger disposed outside of the vehicle 104 and electrically connected directly to EV/PHEV battery 107. This outboard charger may be controlled by the cloud control server 105 substantially similarly to the on-board charger and support substantially similar application programming interface function calls as the charger 106. In one or more embodiments, the system shown In FIG. 1 is configured to provide near real-time (millisecond-level, intra-cycle) response to power excursions on the local power grid 102. This may be implemented using the aforesaid application programming interface of the EVSE 100, which provides near real-time information on the grid power quality. As would be appreciated by persons of ordinary skill in the art, this can dramatically increase power quality across the distribution domain.

### Exemplary Computer Platform

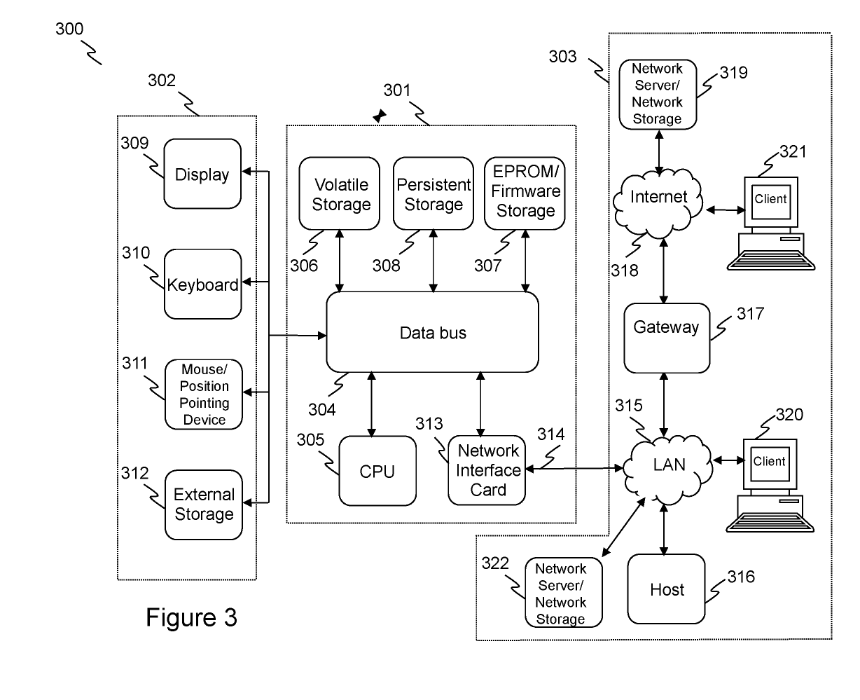

FIG. 3 is a block diagram that illustrates an embodiment of a computer/server system 300 upon which an embodiment of the inventive methodology may be implemented. The system 300 includes a computer/server platform 301, peripheral devices 302 and network resources 303. As would be appreciated by persons of ordinary skill in the art, various embodiments described hereinabove may be deployed based on the aforesaid computer/server system 300, which, in one embodiment, could be used as a building block for the cloud control server 105.

The computer platform 301 may include a data bus 305 or other communication mechanism for communicating information across and among various parts of the computer platform 301, and a processor 305 coupled with bus 301 for processing information and performing other computational and control tasks. Computer platform 301 also includes a volatile storage 306, such as a random access memory (RAM) or other dynamic storage device, coupled to bus 305 for storing various information as well as instructions to be executed by processor 305. The volatile storage 306 also may be used for storing temporary variables or other intermediate information during execution of instructions by processor 305. Computer platform 301 may further include a read only memory (ROM or EPROM) 307 or other static storage device coupled to bus 304 for storing static information and instructions for processor 305, such as basic input-output system (BIOS), as well as various system configuration parameters. A persistent storage device 308, such as a magnetic disk, optical disk, or solid-state flash memory device is provided and coupled to bus 301 for storing information and instructions.

Computer platform 301 may be coupled via bus 305 to a display 309, such as a cathode ray tube (CRT), plasma display, or a liquid crystal display (LCD), for displaying information to a system administrator or user of the computer platform 301. An input device 310, including alphanumeric and other keys, is coupled to bus 301 for communicating information and command selections to processor 305. Another type of user input device is cursor control device 311, such as a mouse, a trackball, or cursor direction keys for communicating direction information and command selections to processor 305 and for controlling cursor movement on display 309. This input device typically has two degrees of freedom in two axes, a first axis (e.g., x) and a second axis (e.g., y), that allows the device to specify positions in a plane.

An external storage device 312 may be coupled to the computer platform 301 via bus 305 to provide an extra or removable storage capacity for the computer platform 301. In an embodiment of the computer system 300, the external removable storage device 312 may be used to facilitate exchange of data with other computer systems.

The invention is related to the use of computer system 300 for implementing the techniques described herein. In an embodiment, the inventive system may reside on a machine such as computer platform 301. According to one embodiment of the invention, the techniques described herein are performed by computer system 300 in response to processor 305 executing one or more sequences of one or more instructions contained in the volatile memory 306. Such instructions may be read into volatile memory 306 from another computer-readable medium, such as persistent storage device 308. Execution of the sequences of instructions contained in the volatile memory 306 causes processor 305 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 305 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 308. Volatile media includes dynamic memory, such as volatile storage 306.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 305 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 305. The bus 305 carries the data to the volatile storage 306, from which processor 305 retrieves and executes the instructions. The instructions received by the volatile memory 306 may optionally be stored on persistent storage device 308 either before or after execution by processor 305. The instructions may also be downloaded into the computer platform 301 via Internet using a variety of network data communication protocols well known in the art.

The computer platform 301 also includes a communication interface, such as network interface card 313 coupled to the data bus 305. Communication interface 313 provides a two-way data communication coupling to a network link 315 that is coupled to a local network 315. For example, communication interface 313 may be an integrated services digital network (ISDN) card or a modem to provide a data communication connection to a corresponding type of telephone line. As another example, communication interface 313 may be a local area network interface card (LAN NIC) to provide a data communication connection to a compatible LAN. Wireless links, such as well-known 802.11a, 802.11b, 802.11g and Bluetooth may also be used for network implementation. In any such implementation, communication interface 313 sends and receives electrical, electromagnetic or optical signals that carry digital data streams representing various types of information.

Network link 315 typically provides data communication through one or more networks to other network resources. For example, network link 315 may provide a connection through local network 315 to a host computer 316, or a network storage/server 317. Additionally or alternatively, the network link 313 may connect through gateway/firewall 317 to the wide-area or global network 318, such as an Internet. Thus, the computer platform 301 can access network resources located anywhere on the Internet 318, such as a remote network storage/server 319. On the other hand, the computer platform 301 may also be accessed by clients located anywhere on the local area network 315 and/or the Internet 318. The network clients 320 and 321 may themselves be implemented based on the computer platform similar to the platform 301.

Local network 315 and the Internet 318 both use electrical, electromagnetic or optical signals that carry digital data streams. The signals through the various networks and the signals on network link 315 and through communication interface 313, which carry the digital data to and from computer platform 301, are exemplary forms of carrier waves transporting the information.

Computer platform 301 can send messages and receive data, including program code, through the variety of network(s) including Internet 318 and LAN 315, network link 315 and communication interface 313. In the Internet example, when the system 301 acts as a network server, it might transmit a requested code or data for an application program running on client(s) 320 and/or 321 through Internet 318, gateway/firewall 317, local area network 315 and communication interface 313. Similarly, it may receive code from other network resources.

The received code may be executed by processor 305 as it is received, and/or stored in persistent or volatile storage devices 308 and 306, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive.

Moreover, other implementations of the invention will be apparent to those skilled in the art from consideration of the specification and practice of the invention disclosed herein. Various aspects and/or components of the described embodiments may be used singly or in any combination in vehicle charging network. It is intended that the specification and examples be considered as exemplary only, with a true scope and spirit of the invention being indicated by the following claims.

What is claimed is:

1. An electric or hybrid-electric vehicle comprising:
a. a vehicle battery adopted to store electrical power;
b. a battery charger electrically coupled to the battery and configured to perform charging of the vehicle battery from an external power source; and
c. a battery management system electrically coupled to the vehicle battery and the battery charger and configured to manage a state of the vehicle battery, wherein at least one of the battery, the battery charger or the battery management system comprises an application programming interface accessible, via a data network, by an application program executing on a remote control server comprising at least one processing unit and a memory.

2. The electric or hybrid-electric vehicle of claim 1, wherein the battery management system of the vehicle comprises the application programming interface.

3. The electric or hybrid-electric vehicle of claim 2, wherein the application programming interface is configured to enable the application program executing on the remote control server to access cost of control data for the vehicle battery.

4. The electric or hybrid-electric vehicle of claim 2, wherein the cost of control data for the vehicle battery indicates physical degradation of the vehicle battery from a predetermined operating mode.

5. The electric or hybrid-electric vehicle of claim 2, wherein the battery management system is configured to receive, via the application programming interface, a command from the application program executing on the remote control server.

6. The electric or hybrid-electric vehicle of claim 5, wherein the battery management system is further configured to alter its operating mode based on the command received from the application program executing on the remote control server.

7. The electric or hybrid-electric vehicle of claim 5, wherein the command as an application programming interface function call.

8. The electric or hybrid-electric vehicle of claim 1, wherein the battery of the vehicle comprises the application programming interface.

9. The electric or hybrid-electric vehicle of claim 1, wherein the battery charger of the vehicle comprises the application programming interface.

10. The electric or hybrid-electric vehicle of claim 9, wherein the battery charger is configured to receive, via the application programming interface, a command from the application program executing on the remote control server.

11. The electric or hybrid-electric vehicle of claim 10, wherein the battery charger is further configured to alter its operating mode based on the command received from the application program executing on the remote control server.

12. The electric or hybrid-electric vehicle of claim 10, wherein the command received from the application program executing on the remote control server causes the battery charger to alter a reactive power load.

13. The electric or hybrid-electric vehicle of claim 12, wherein the command as an application programming interface function call.

14. The electric or hybrid-electric vehicle of claim 1, wherein the application program executing on a remote control server is configured to determine power quality of a local power grid to detect power excursions and provide a near real-time response to the detected power excursions.

15. The electric or hybrid-electric vehicle of claim 14, wherein the response to the detected power excursions comprises directing a portion of electrical energy from the vehicle battery to the local power grid.

16. A method performed in connection with an electric or hybrid-electric vehicle comprising:
a. providing a vehicle battery adopted to store electrical power;
b. charging of the vehicle battery from an external power source using a battery charger electrically coupled to the battery; and
c. managing a state of the vehicle battery using a battery management system electrically coupled to the vehicle battery and the battery charger, wherein at least one of the battery, the battery charger or the battery management system comprises an application programming interface accessible, via a data network, by an application program executing on a remote control server comprising at least one processing unit and a memory.

17. The method of claim 16, wherein the battery management system of the vehicle comprises the application programming interface.

18. The method of claim 17, wherein the application programming interface is configured to enable the application program executing on the remote control server to access cost of control data for the vehicle battery.

19. The method of claim 17, wherein the cost of control data for the vehicle battery indicates physical degradation of the vehicle battery from a predetermined operating mode.

20. The method of claim 17, wherein the battery management system is configured to receive, via the application programming interface, a command from the application program executing on the remote control server.

21. The method of claim 20, wherein the battery management system is further configured to alter its operating mode based on the command received from the application program executing on the remote control server.

22. A non-transitory computer-readable medium embodying a set of instructions, which, when executed in connection with an electric or hybrid-electric vehicle comprising a vehicle battery adopted to store electrical power, a battery charger electrically coupled to the battery; and a battery management system electrically coupled to the vehicle battery and the battery charger, cause the electric or hybrid-electric vehicle to:
a. charge the vehicle battery from an external power source using the battery charger; and
b. manage a state of the vehicle battery using the battery management system, wherein at least one of the battery, the battery charger or the battery management system comprises an application programming interface accessible, via a data network, by an application program executing on a remote control server comprising at least one processing unit and a memory.
